(19) United States
(12) Patent Application Publication
(10) Pub. No.: US 2012/0260575 A1
(43) Pub. Date: Oct. 18, 2012

(54) SMART GARAGE DOOR OPENER

(76) Inventor: Pietro A. Monaco, Shelby Twp., MI (US)

(21) Appl. No.: 13/084,617

(22) Filed: Apr. 12, 2011

(51) Int. Cl. E05F 15/20

(52) U.S. Cl. 49/13; 49/31

(57) ABSTRACT

A system may include a motor, a control module, and a sensor. The motor may be adapted to drivingly engage a drive mechanism for moving a door between an open position and a closed position. The control module may be in communication with the motor and operable to control operation of the motor. The sensor may be in communication with the control module. The sensor may be operable to detect a substance within a space and send a first signal to the control module indicative of a predetermined level of the substance within the space. The control module may cause the motor to drive the drive mechanism in a direction that causes the door to move from the closed position to the open position in response to receiving the first signal from the first sensor.

### FIELD

The present invention relates to a system for controlling movement of a door, and particularly, movement of a garage door.

### BACKGROUND

Many storage and/or vehicle parking areas such as garages associated with residential, commercial or industrial buildings include a door and a door opener system. Such door opener systems typically include a motor and a drive mechanism driven by the motor that is operable to open and close the door. A button or switch electrically connected to the motor is often mounted within the garage. A person can actuate the button or switch to cause the motor and drive mechanism to open and close the door to control access to the garage and selectively allow and prevent ingress into and egress out of the garage.

In addition to vehicles, a variety of tools, equipment, household products, and/or other items are often found in parking areas and garages. Homeowners sometimes use a garage as a workshop in which to perform projects, chores and/or hobbies. Garages may lack climate control and/or adequate ventilation systems. In light of the foregoing, garages may be susceptible to fire and/or accumulation of harmful or noxious substances. Such conditions may go unnoticed and become hazardous to human and/or animal health, safety and/or property.

### SUMMARY

In one form, the present disclosure provides a system that may include a motor, a control module, and a sensor. The motor may be adapted to drivingly engage a drive mechanism for moving a door between an open position and a closed position. The control module may be in communication with the motor and may control operation of the motor. The sensor may be in communication with the control module. The sensor may be operable to detect smoke within a space and send a first signal to the control module indicative of a predetermined level of smoke within the space. The control module may cause the motor to drive the drive mechanism in a direction that causes the door to move from the closed position to the open position in response to receiving the first signal from the first sensor.

In some embodiments, the first sensor and/or the motor may be mounted to or within a housing and the space may include an interior of a garage.

In some embodiments, the control module may cause movement of the motor in response to the first sensor detecting the predetermined level of smoke only when the door is not in the open position.

In some embodiments, the system may include a transmitter in wireless communication with the control module and the first sensor. The transmitter and the first sensor may be mounted to a vehicle.

In some embodiments, the system may include a second sensor in communication with the control module that may be operable to detect a substance within the space and send a second signal to the control module indicative of a predetermined level of the substance within the space.

In some embodiments, the system may include a source of electrical power and at least one battery coupled for electrical communication with the control module, the motor and the first and second sensors. The battery may be operable to supply electrical current to the control module, the motor, and the first and second sensors during an event whereby the source of electrical power is disabled.

In some embodiments, the system may include a transmitter in wireless communication with said control module and at least one of said first and second sensors, wherein at least one of said transmitter and said first and second sensors are mounted to a vehicle.

In some embodiments, the system may include an alarm configured to generate an audible alarm in response to the first signal. The alarm may continue to generate the audible alarm until a level of smoke within the space is less than the predetermined level of smoke.

In another form, the present disclosure provides a vehicle that may include a transmitter and a first sensor. The transmitter may be mounted to the vehicle and may be adapted to transmit a wireless signal. The first sensor may be mounted to the vehicle and may be in communication with the transmitter. The first sensor may be operable to detect a first substance (e.g., smoke) within a space and send a first signal to the transmitter in response to detecting a predetermined level of the first substance. The transmitter may transmit the wireless signal in response to receiving the first signal. The wireless signal may cause movement of a motor associated with a door.

In some embodiments, the vehicle may include a second sensor mounted to the vehicle and in communication with the transmitter. The second sensor may be operable to detect a second substance outside of the vehicle and send a second signal to said transmitter in response to detecting a predetermined level of said substance, said transmitter transmitting said wireless signal in response to receiving said second signal to cause movement of said motor. In some embodiments, the second sensor may include a carbon monoxide detector.

In some embodiments, the vehicle may include a button disposed within a cab of the vehicle and in communication with the transmitter. The button may be adapted to be manually actuated to cause movement of the motor on demand.

A system may be in wireless communication with the vehicle. The system may include a control module and the motor. The control module may be in communication with the motor. The transmitter may be adapted to communicate the wireless signal to the control module. In some embodiments, the control module may cause movement of the motor in a direction corresponding to movement of the door to an open position in response to the first sensor detecting the predetermined level of the first substance. In some embodiments, the control module allows the motor to remain at rest in response to the control module receiving the wireless signal when the door is in the open position. In some embodiments, the system may include an alarm in communication with the control module and adapted to generate at least one of an audible and a visual alarm indicative of the first sensor detecting the predetermined level of the first substance.

In some embodiments, the system may include first and second sources of electrical power in communication with the control module and the motor. The second source of electrical power may supply electrical current to the control module and the motor during a power-outage event preventing the first source of electrical power from supplying electrical current to the control module and the motor.

In another form, the present disclosure provides a system that may include a sensor and a control module. The sensor may be configured to detect at least one of a combustible substance and smoke. The sensor may generate a first signal indicative of a level of the at least one of the combustible substance and smoke. The control module may be in communication with the sensor and may generate a second signal controlling movement of a door based on the first signal from the sensor.

In some embodiments, the second signal may be generated in response to detection of a predetermined level of the at least one of the combustible substance and smoke. In some embodiments, at least one of the sensor and the control module may be adjustable to customize the predetermined level.

Further areas of applicability of the present disclosure will become apparent from the detailed description, claims and drawings provided hereinafter. It should be understood that the detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic representation of a garage including the garage door opener unit and a garage door in a closed position;

FIG. 2 is schematic representation of the garage of FIG. 1 with the garage door in an open position;

FIG. 3 is a block diagram depicting a garage door opener unit according to the principles of the present disclosure;

FIG. 4 is a schematic representation of a garage door opener system according to the principles of the present disclosure; and

FIG. 5 is a partial perspective view of an interior of a vehicle according to the principles of the present disclosure.

### DETAILED DESCRIPTION

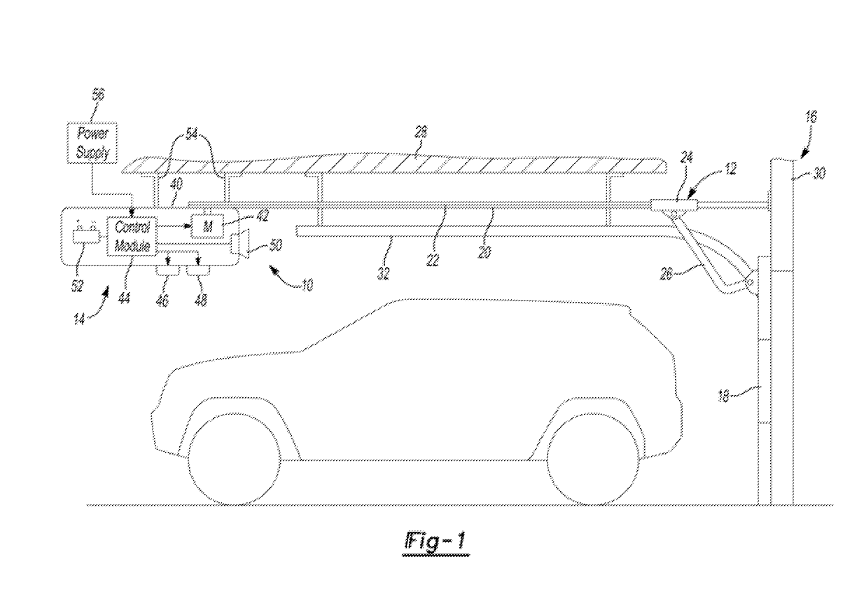

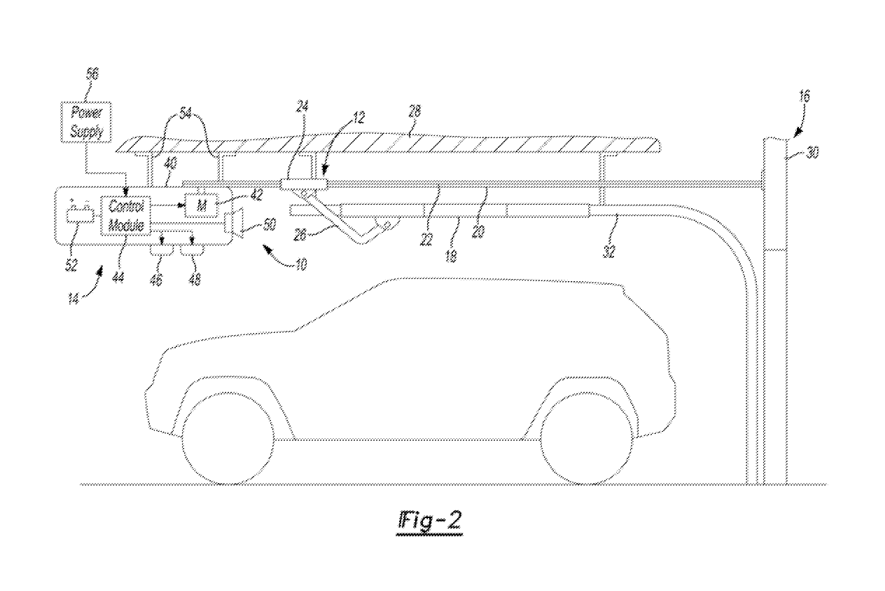

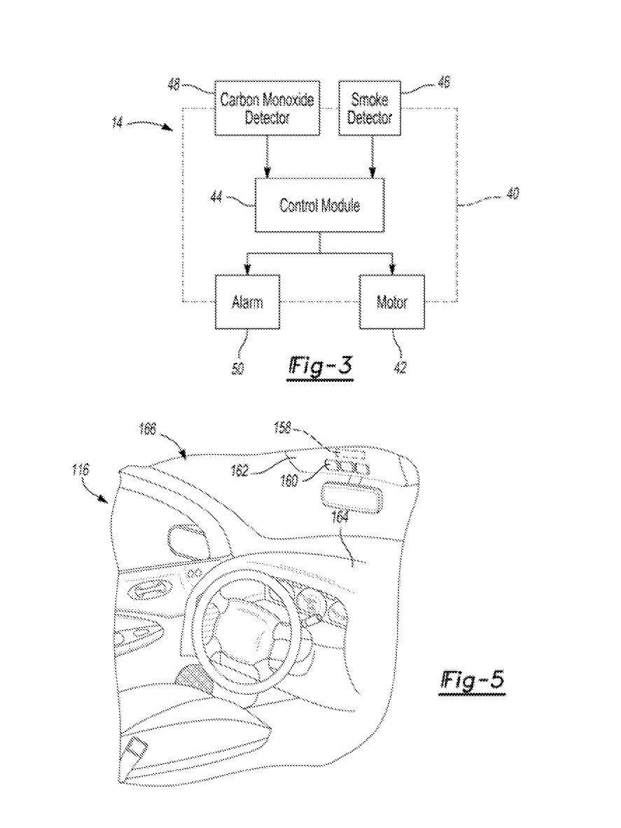

In an exemplary embodiment and with reference to FIGS. 1-3, a system 10 is provided and may include a drive mechanism 12 and a garage door opener unit 14 and may be installed in a vehicle parking space such as a garage 16, for example. The garage door opener unit 14 and the drive mechanism 12 may cooperate to move a garage door 18 relative to the garage 16 between a closed position (FIG. 1) and an open position (FIG. 2). The garage 16 may be a stand-alone garage or the garage 16 may be connected to or otherwise associated with a residential, commercial or industrial building, for example, or any other building. As will be subsequently described, the system 10 may be operable to control movement of the garage door 18 in response to detection of one or more hazardous, destructive and/or otherwise undesirable substances or conditions within the garage 16.

In some exemplary embodiments, the system 10 may include one or more sensors configured to detect a predetermined level or concentration of an undesirable substance in the garage 16 or vehicle space. The undesirable substance can be in various forms such as, for example, gaseous, vapor or a combination thereof like smoke. The sensors may generate a signal for directing the opening of the garage door 18, and in some embodiments, the sensors may direct a signal for generating an alarm or notification to alert people nearby of the undesirable substance or condition in the garage. In some embodiments, the predetermined threshold levels or concentrations of the substances may correspond to human and/or animal sensitivities or tolerance levels.

The drive mechanism 12 may include a guide rail 20, a drive belt or chain 22, a slider 24 and an arm 26. The guide rail 20 may be an elongated member fixed to a ceiling 28 and/or a wall 30 of the garage 16. The drive chain 22 may engage the slider 24 and propel the slider 24 along the guide rail 20 between the open and closed positions. The arm 26 may pivotably engage the slider 24 and the garage door 18 such that movement of the slider 24 relative to the guide rails 20 causes corresponding movement of the garage door 18 between the open and closed positions along a track 32 mounted to the ceiling 28 and/or the wall 30. It will be appreciated that the drive mechanism 12 could be configured in any other suitable manner to move the garage door 18 between the open and closed positions.

In an exemplary embodiment, the garage door opener unit 14 may include a housing 40, a motor 42, a control module 44, a smoke detector 46, a carbon monoxide detector 48, an alarm 50 and one or more batteries 52. The housing 40 may be an enclosure formed from plastic and/or any other suitable material and may be fixed to the ceiling 28 via one or more brackets 54, for example. The motor 42 may be attached to or at least partially enclosed within the housing 40 and may drivingly engage the drive chain 22 of the drive mechanism 12.

The control module 44 may be enclosed within or attached to the housing 40. The control module 44 may be in communication with the motor 42 and control operation of the motor 42 to selectively cause the motor 42 to propel the drive mechanism 12 to move the garage door 18 between the open and closed positions. The control module 44 may receive electrical power from a hardwired power supply 56 of the garage 16 and/or an associated house or other building, for example. The control module 44 may refer to, be part of, or include an Application Specific Integrated Circuit (ASIC), an electronic circuit, a processor (shared, dedicated or group) and/or memory (shared, dedicated or group) that execute one or more software or firmware programs, a combinational logic circuit and/or other suitable components that provide the described functionality.

The smoke detector 46 may be mounted to or partially enclosed within the housing 40 and may include one or more sensors operable to detect smoke within the garage 16. The smoke detector 46 may be in communication with the control module 44 and may send a signal to the control module 44 indicating that the smoke detector 46 has detected a predetermined amount or concentration of smoke within the garage 16. The predetermined concentration of smoke may be a concentration that is associated with a relatively high likelihood of a fire within or proximate to the garage 16 and/or a level or concentration that renders the air quality within the garage 16 harmful to a person's or animal's health or wellbeing, for example.

The carbon monoxide detector 48 may be mounted to or partially enclosed within the housing 40 and may include one or more sensors operable to detect carbon monoxide within the garage 16. The carbon monoxide detector 48 may be in communication with the control module 44 and may send a signal to the control module 44 indicating that the carbon monoxide detector 48 has detected a predetermined amount or concentration of carbon monoxide within the garage 16. The predetermined concentration of carbon monoxide may be a concentration that renders the air quality within the garage 16 harmful to a person's or animal's health or wellbeing, for example.

In some embodiments, the control module 44, smoke detector 46 and/or the carbon monoxide detector 48 may be adjustable so that the predetermined concentration or level of smoke and/or carbon monoxide may be customized to account for the sensitivities or tolerances of a particular person, animal or item that may be near or within the garage 16.

The alarm 50 may be mounted to or at least partially enclosed within the housing 40 and may be in communication with the control module 44 and/or the detectors 46, 48. The alarm 50 may include a speaker and/or one or more lights. The alarm 50 may generate an audible sound and/or a visual warning indicating that the smoke detector 46 has detected the predetermined amount or concentration of smoke and/or that the carbon monoxide detector 48 has detected the predetermined amount or concentration of carbon monoxide. In some embodiments, the audible sound and/or a visual warning generated by the alarm 50 may continue until the level or concentration of the substance is below the predetermined threshold level or concentration or until the alarm 50 is manually stopped or reset.

The one or more batteries 52 may be mounted to or at least partially enclosed within the housing 40 and may be in communication with one or more of the motor 42, the control module 44, the smoke detector 46, the carbon monoxide detector 48, and the alarm 50. The one or more batteries 52 may supply electrical current to the motor 42, the control module 44, the smoke detector 46, the carbon monoxide detector 48, and/or the alarm 50 in the event of a power outage, a disconnection from the power supply 56 or any other fault condition restricting or preventing a flow of electrical current from the power supply 56 to one or more components of the garage door opener unit 14.

While not specifically shown in FIGS. 1-3, it will be appreciated that the control module 44 and/or the motor 42 may be responsive to a user interface, such as a hardwired button or switch or a remote transmitter, such that a user may actuate the button, switch or remote transmitter to cause the motor 42 to open or close the garage door 18 on demand.

With continued reference to FIGS. 1-3, operation of the system 10 will be described in detail. If and when the smoke detector 46 detects the predetermined concentration of smoke and/or the carbon monoxide detector 48 detects the predetermined concentration of carbon monoxide within the garage 16, the respective detector 46, 48 may send a corresponding signal to the control module 44 indicating the presence of the predetermined concentration of smoke and/or carbon monoxide. The control module 44 may then determine whether the garage door 18 is in the open position or the closed position by detecting a position of the motor 42, drive mechanism 12, and/or garage door 18 or by retrieving such information from its memory, for example.

If the control module 44 receives a signal from either or both of the smoke detector 46 and the carbon monoxide detector 48 and the control module 44 determines that the garage door 18 is in the closed position or between the open position and the closed position, the control module 44 may send a signal to the motor 42 causing the motor 42 to drive the drive mechanism 12 in a direction causing the garage door 18 to move into the open position. However, if the control module 44 determines that the garage door 18 is in the open position, the control module 44 will not send a signal to the motor 42 causing the motor 42 to move the garage door 18, even if the control module 44 receives a signal from either or both of the smoke detector 46 and the carbon monoxide detector 48. Moving the garage door 18 into the open position or maintaining the garage door 18 in the open position in this manner may allow smoke, carbon dioxide and/or other dangerous or harmful air contaminants to flow out of the garage 16 and/or dissipate.

In some embodiments, the system 10 can be configured so that the alarm 50 generates the audible and/or visual warning or indication even though the system 10 has determined that the garage door 18 is in the open position. The audible and/or a visual warning generated by the alarm 50 may continue until the level or concentration of the substance is below the predetermined threshold level or concentration or until the alarm 50 is intentionally stopped or reset.

Regardless of whether the control module 44 determines that the garage door 18 is in the open or closed position or between the open and closed positions, if and when the control module 44 receives the signal from either or both of the smoke detector 46 and the carbon monoxide detector 48 indicating that the predetermined concentrations of smoke and/or carbon monoxide have been detected, the control module 44 may send a signal to the alarm 50 causing the alarm 50 to generate the audible and/or visual warnings. In this manner, the alarm 50 may gain attention from people within or near the general vicinity of the garage 16 so that the people may notify emergency personnel and/or take other precautionary and/or remedial action.

It will be appreciated that the system 10 could include one or more additional or alternative sensors in communication with the control module 44 configured to detect one or more other substances. For example, the system 10 could include a sensor operable to detect a combustible substance, such as gasoline fumes or vapors and/or chemical fumes or vapors. In such embodiments, the control module 44 could activate the alarm 50 and/or cause the garage door 18 to open in response to detection of a predetermined level of the one or more substances.

The control module 44 and/or any of the sensors described above may be adjustable so that a user can customize the predetermined level at which the control module 44 causes movement of the garage door 18 and/or activates or shuts down the alarm 50. The predetermined level can be customized to correspond to or account for a tolerance or sensitivity level or medical condition of a particular human, animal or item that may be near or within the garage 16.

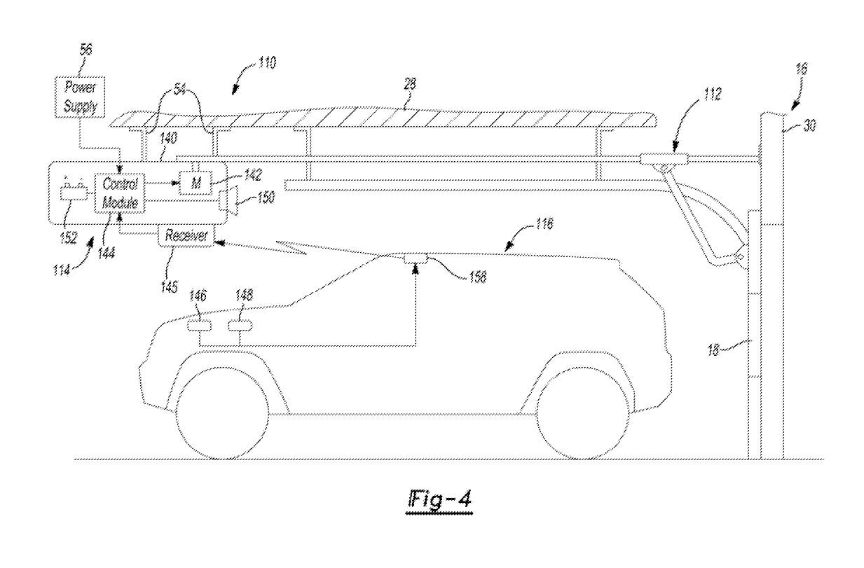

In another exemplary embodiment and with reference to FIGS. 4 and 5, a system 110 is provided that may include a drive mechanism 112, a garage door opener unit 114, and a vehicle 116. The drive mechanism 112 and the garage door opener unit 114 may be installed in the garage 16 and may cooperate to move the garage door 18 between the open and closed positions, as described above with regard to the system 10. The structure and function of the drive mechanism 112 may be substantially similar to the structure and function of the drive mechanism 12 described above, and therefore, will not be described again in detail.

The garage door opener unit 114 may include a housing 140, a motor 142, a control module 144, a receiver 145, an alarm 150, and one or more batteries 152. The structure and function of the housing 140, motor 142, control module 144, alarm 150, and batteries 152 may be substantially similar to the structure and function of the housing 40, motor 42, control module 44, alarm 50, and battery 52 described above apart from any exceptions noted below. The receiver 145 may be mounted to or at least partially enclosed within the housing 140. The receiver 145 may be in communication with the control module 144 and may be configured to receive a radio-frequency (RF) signal, an infrared (IR) signal and/or any other wireless signal. In some configurations, the receiver 145 may be integrated into or may be a part of the control module 144.

The vehicle 116 may be any type of vehicle, including any type of electric, hybrid, gasoline or diesel car, truck, sport-utility vehicle, crossover sport-utility vehicle, van, or minivan, for example. The vehicle 116 may include a smoke detector 146, a carbon monoxide detector 148, a transmitter 158, and a user interface 160. The smoke detector 146 and carbon monoxide detector 148 may be mounted to the vehicle 116 in any suitable location, such as a location that is spaced apart from any exhaust pipe(s) (not shown) of the vehicle 116 to detect a concentration or amount of smoke and carbon monoxide, respectively, within the garage 16.

Similar to the smoke detector 46 described above, the smoke detector 146 may be in communication with the control module 144 and may send a signal to the control module 144 indicating that the smoke detector 146 has detected the predetermined amount or concentration of smoke within the garage 16. Similar to the carbon monoxide detector 48 described above, the carbon monoxide detector 148 may be in communication with the control module 144 and may send a signal to the control module 144 indicating that the carbon monoxide detector 148 has detected the predetermined amount or concentration of carbon monoxide within the garage 16.

The transmitter 158 may be mounted to or within the vehicle 116 in any suitable location, such as in or near a headliner 162 or dashboard 164 in an interior 166 of the vehicle 116, for example. The transmitter 158 may be in configured to transmit a wireless signal, such as an RF or IR signal, for example. In this manner, the transmitter 158 may wirelessly communicate with the receiver 145. As described above, the receiver 145 is in communication with the control module 144, which in turn, is in communication with the motor 142 to selectively cause the motor 142 to move the garage door 18 between the open and closed positions.

The user interface 160 may be a button or switch, for example, disposed on or near the headliner 162, dashboard 164, or a sun visor (not shown) for example, and may be in communication with the transmitter 158. A user may actuate the user interface 160 to cause the transmitter 158 to send a wireless signal to the receiver 145 causing the motor 142 to move the garage door 18 between the open and closed positions on demand.

With continued reference to FIGS. 4 and 5, operation of the system 110 will be described in detail. If and when the smoke detector 146 detects the predetermined concentration of smoke and/or the carbon monoxide detector 148 detects the predetermined concentration of carbon monoxide within the garage 16, the respective detector 146, 148 may send a corresponding signal to the transmitter 158 indicating the presence of the predetermined concentration of smoke and/or carbon monoxide. In response to receiving such information from the smoke detector 146 and/or the carbon monoxide detector 148, the transmitter 158 may transmit a wireless signal to the receiver 145 indicating that the smoke detector 146 and/or the carbon monoxide detector 148 has detected at least the predetermined concentration of smoke and/or carbon monoxide, respectively. Upon receiving the wireless signal from the transmitter 158, the receiver 145 may send a signal to the control module 144 indicating that the smoke detector 146 and/or the carbon monoxide detector 148 has detected at least the predetermined concentration of smoke and/or carbon monoxide, respectively.

As described above with respect to the system 10, the control module 144 may then determine whether the garage door 18 is in the open position or the closed position by detecting a position of the motor 142, drive mechanism 112, and/or garage door 18 or by retrieving such information from its memory, for example. If and when the control module 144 receives the signal from the receiver 145 indicating that the smoke detector 146 and/or the carbon monoxide detector 148 has detected at least the predetermined concentration of smoke and/or carbon monoxide, respectively, and the control module 144 determines that the garage door 18 is in the closed position or between the open position and the closed position, the control module 144 may send a signal to the motor 142 causing the motor 142 to drive the drive mechanism 112 in a direction causing the garage door 18 to move into the open position.

If the control module 144 determines that the garage door 18 is in the open position, the control module 144 will not send a signal to the motor 142 causing the motor 142 to move the garage door 18 in response to receiving the signal indicating that the smoke detector 146 and/or the carbon monoxide detector 148 has detected at least the predetermined concentration of smoke and/or carbon monoxide, respectively. As described above, regardless of the position of the garage door 18, if and when the control module 144 receives the signal indicating that the predetermined concentrations of smoke and/or carbon monoxide have been detected, the control module 144 may send a signal to the alarm 150 causing the alarm 150 to generate the audible and/or visual warnings.

A user may override the above-described functionality of the control module 144 by manually actuating the user interface 160. Actuation of the user interface 160 may cause the transmitter 158 to send a wireless override signal to the receiver 145 causing the motor 142 to move the garage door 18 between the open and closed positions on demand.

As described above any of the sensors and/or the control module 144 may be adjustable so that a user can customize the predetermined level at which the control module 144 causes movement of the garage door 18 and/or activates or shuts down the alarm 150. The predetermined level can be customized to correspond to or account for a tolerance or sensitivity level or medical condition of a particular human, animal or item that may be near or within the garage 16.

While the garage door opener unit 14 and the vehicle 116 are described above as including one or more of the smoke detectors 46, 146 and the carbon monoxide detectors 48, 148, it will be appreciated that the garage door opener unit 14, 114 and/or the vehicle 116 could additionally or alternatively include one or more other detectors or sensors operable to detect other noxious or hazardous fumes or gases and/or other conditions indicating poor air quality or a hazardous condition within the garage 16.

While the systems 10, 110 are described herein as being installed in the garage 16 to open and close the garage door 18, it will be appreciated that the systems 10, 110 could be installed in any other building, structure or space to move any other type of door or window between open and closed positions. For example, one or more of the sensors 46, 48, 146, 148 may be mounted in a location suited to detect smoke, carbon dioxide and/or other fumes or gases within the interior 166 of the vehicle 116, for example, and the system 10, 110 may be configured to move a window and/or a door of the vehicle 116 between open and closed positions in response to detection of a predetermined concentration or amount of smoke, carbon dioxide and/or other fumes or gases.

In some embodiments, regardless of the position of the garage door 18, the system 110 can be configured so the transmitter 158 can send a signal to the receiver 145 for operation of the alarm 150, or directly to the alarm 150, to maintain operation of the alarm 150 for a predetermined amount of time or until the alarm 150 is manually turned off. In another embodiment, the system can be configured so the transmitter 158 sends a signal to an alarm positioned on the vehicle 116 to provide an alert of a predetermined level or concentration of an undesirable substance in the vicinity of the vehicle 116. In some embodiments, the system 10, 110 can include backup or redundant sensors that detect the same one or more substances as any of the sensors described above.

What is claimed is:

1. A system comprising:
a motor adapted to drivingly engage a drive mechanism for moving a door between an open position and a closed position;
a control module in communication with said motor and operable to control operation of said motor; and
a first sensor in communication with said control module, said first sensor being operable to detect smoke within a space and send a first signal to said control module indicative of a predetermined level of smoke within said space,
wherein said control module causes said motor to drive said drive mechanism in a direction that causes said door to move from said closed position to said open position in response to receiving said first signal from said first sensor.

2. The system of claim 1, further comprising a housing, said first sensor and said motor being mounted to said housing.

3. The system of claim 1, wherein said control module causes movement of said motor in response to said first sensor detecting said predetermined level of smoke only when said door is not in said open position.

4. The system of claim 1, further comprising a transmitter in wireless communication with said control module and said first sensor, wherein said transmitter and said first sensor are mounted to a vehicle.

5. The system of claim 1, further comprising a second sensor in communication with said control module, said second sensor being operable to detect a substance within said space and send a second signal to said control module indicative of a predetermined level of said substance within said space.

6. The system of claim 5, further comprising a source of electrical power and at least one battery coupled for electrical communication with said control module, said motor and said first and second sensors, said battery being operable to supply electrical current to said control module, said motor, and said first and second sensors during an event whereby said source of electrical power is disabled.

7. The system of claim 1, further comprising an alarm configured to generate an audible alarm in response to said first signal.

8. The system of claim 7, wherein said alarm is configured to continue to generate said audible alarm until a level of smoke is less than said predetermined level of smoke.

9. The system of claim 1, further comprising:
a second sensor in communication with said control module and operable to detect a substance and send a second signal to said control module indicative of a predetermined level of said substance; and
a transmitter in wireless communication with said control module and at least one of said first and second sensors, wherein at least one of said transmitter and said first and second sensors are mounted to a vehicle.

10. The system of claim 1, wherein said space includes an interior of a garage and said door is a garage door.

11. A vehicle comprising:
a transmitter mounted to the vehicle and adapted to transmit a wireless signal; and
a first sensor mounted to the vehicle and in communication with said transmitter, said first sensor being operable to detect smoke within a space and send a first signal to said transmitter in response to detecting a predetermined level of smoke, said transmitter transmitting said wireless signal in response to receiving said first signal, said wireless signal causing movement of a motor associated with a door.

12. The vehicle of claim 11, further comprising a second sensor mounted to the vehicle and in communication with said transmitter, said second sensor being operable to detect a substance outside of the vehicle and send a second signal to said transmitter in response to detecting a predetermined level of said substance, said transmitter transmitting said wireless signal in response to receiving said second signal to cause movement of said motor.

13. A system in wireless communication with the vehicle of claim 11, the system comprising a control module and said motor, said control module being in communication with said motor, wherein said transmitter is adapted to communicate said wireless signal to said control module.

14. The system of claim 13, wherein said control module causes movement of said motor in a direction corresponding to movement of said door to an open position in response to said first sensor detecting said predetermined level of smoke.

15. The system of claim 14, wherein said control module allows said motor to remain at rest in response to said control module receiving said wireless signal when said door is in said open position.

16. The system of claim 13, further comprising an alarm in communication with said control module and adapted to generate at least one of an audible and a visual alarm indicative of said first sensor detecting said predetermined level of smoke.

17. The system of claim 13, further comprising first and second sources of electrical power in communication with said control module and said motor, said second source of electrical power supplying electrical current to said control module and said motor during a power-outage event preventing said first source of electrical power from supplying electrical current to said control module and said motor.

18. The vehicle of claim 11, wherein said space includes an interior of a garage and said door is a garage door.

19. A system comprising:
a sensor configured to detect at least one of a combustible substance and smoke, said sensor generating a first signal indicative of a level of said at least one of said combustible substance and smoke; and
a control module in communication with said sensor and generating a second signal controlling movement of a door based on said first signal from said sensor.

20. The system of claim 19, wherein said second signal is generated in response to detection of a predetermined level of said at least one of said combustible substance and smoke, wherein at least one of said sensor and said control module is adjustable to customize said predetermined level.
